(19) United States
(12) Patent Application Publication
(10) Pub. No.: US 2008/0161951 A1
(43) Pub. Date: Jul. 3, 2008

(54) Portable memory device with dynamically loaded audio content

(76) Inventor: Jeffrey M. Morris, Buffalo Grove, IL (US)

Correspondence Address: RYNDAK & SURI LLP, 200 W. MADISON STREET, SUITE 2100, CHICAGO, IL, 60606, US

(21) Appl. No.: 11/807,931

(22) Filed: May 30, 2007

Related U.S. Application Data
(63) Continuation-in-part of application No. 11/648,922, filed on Jan. 3, 2007.

(51) Int. Cl. G06F 17/00

(52) U.S. Cl. 700/94

(57) ABSTRACT

A USB flash memory device is provided which, when inserted into a USB port of a personal computer, automatically connects to a remote central management system via a wide area network such as the Internet to download updated audio and plays recorded audio. The housing of the memory device may be imprinted with promotional information. The recorded audio may include a promotional message, a message relating to a sweepstakes or other contest or any other information. The memory device includes a sound chip which includes its own memory that stores the recorded message. The sound chip of the memory device may be pre-recorded in mass with an initial message. Power to the memory device is supplied by the personal computer. The central management system stores and provides updated audio content for the flash memory device, and stores statistical data concerning use of the flash memory device.

### RELATED APPLICATION

This application is a continuation-in-part of Application Ser. No. 11/648,922 filed Jan. 3, 2007.

### FIELD OF THE INVENTION

The present invention relates to flash memory drives and more particularly to a dynamically loaded USB flash memory device which automatically plays prerecorded audio when the memory device is inserted into a USB port of a personal computer and automatically connects the computer to a central computer to search for and download updated audio content.

### BACKGROUND OF THE INVENTION

Flash memory cards have become widely used due to their small physical size, large memory capacity, easy portability, high reliability, fast access speed and increasingly lower cost. In particular, USB memory sticks, also called USB flash drives, thumb drives, and pen drives (for their shape resembling a writing pen), are used for transporting data between personal computers (“PC's”). They are NAND-type flash memory storage devices integrated with a USB (Universal Serial Bus) interface. They are small, lightweight, removable, portable and rewritable. A USB memory stick has electronic components mounted on a printed circuit board encased in a plastic or metal housing, with a USB connector protruding from one end. A removable cap is often provided to protect the connector, reduce the risk of damage caused by static electricity, and enhance the appearance of the memory stick. The housing may have an aperture to permit attachment of the memory stick to a keychain or lanyard.

The USB memory stick is simply inserted into an available USB port on a PC, and the operating system of the PC recognizes it as a device, e.g., a disk drive. The user may then access files stored on the memory stick, copy them to a hard drive of the PC, and copy files from the hard drive of the PC to the memory stick.

USB memory sticks have also become popular promotional items of the type given by businesses to customers and prospective customers, for example, at trade shows. The housing of the memory sticks can be imprinted with the business's name, logo, contact information and/or a promotional message. Since the USB memory stick is a useful device, the recipient is likely to keep it and use it on a regular basis, and each time he uses it will see the promotional message and be reminded of the business.

Of course, some users will not necessarily pay attention to a printed promotional message. A need therefore exists for an improved USB memory device which will capture and hold the user's attention.

In addition, a need exists for a USB memory device that will stand out from other promotional items and provide a promotional message to a user in a memorable fashion.

There is also a need for a USB memory device the promotional content of which can be dynamically and remotely updated.

### BRIEF SUMMARY OF THE INVENTION

In accordance with one aspect of the present invention, a portable data storage device comprises a connective port electrically connectable to a host machine, whereby the host machine provides power to the portable data storage device, a non-volatile memory unit, a sound transducer, a sound unit for storing audio content and playing the audio through the sound transducer when the connective port is connected to the host machine, and an interface for automatically connecting to a remote computer and downloading updated audio content.

In one embodiment of the present invention, the non-volatile memory of the portable data storage is flash memory.

In one embodiment of the present invention, the connective port is a USB port.

In accordance with another aspect of the present invention, the audio content is a promotional message.

In accordance with another aspect of the present invention, a system for dynamically updating audio content stored in portable data storage devices includes a central management system with a database and a plurality of portable data storage devices, each portable data storage device comprising a connective port being electrically connectable to a host machine, a non-volatile memory unit, a memory controller for controlling the transfer of data between the non-volatile memory and the host machine via the connective port, a loudspeaker, a sound unit for storing recorded audio content and playing the stored audio content through the speaker when the port is connected to the host machine, and interface software stored in the non-volatile memory unit for automatically connecting the host machine to the central management system, receiving updated audio content from the central management system, and storing the updated audio content in the sound unit.

In another aspect of the invention, a method for dynamically updating and playing audio content from a portable data storage device, comprises providing a portable data storage device having a connective port electrically connectable to a host machine whereby the host machine provides power to the portable data storage device, a non-volatile memory unit, a memory controller for controlling the transfer of data between the non-volatile memory and the host machine via the connective port, a sound transducer, and a sound unit; storing audio content in the sound unit; automatically connecting the host machine to a remote server and receiving updated audio content from the remote server when the connective port is connected to the host machine; and automatically playing the audio content from the sound unit through the sound transducer.

### BRIEF DESCRIPTION OF THE SEVERAL VIEWS OF THE DRAWINGS

FIG. 1 is a top view of one embodiment of a USB memory stick in accordance with the invention;

FIG. 2 is an exploded perspective view of the housing for a USB memory stick in accordance with the invention;

FIG. 3A is a top view of a printed circuit board showing the primary electronic components of one embodiment of a USB memory stick in accordance with the invention;

FIG. 3B is a bottom view of a printed circuit board of one embodiment of a USB memory stick in accordance with the invention; and

FIG. 4 is a schematic diagram of an exemplary audio circuit of a USB memory stick with an auto-play audio capability in accordance with the invention.

FIG. 5 is a flowchart of the operation of the USB memory stick of the invention with dynamically updated audio.

FIG. 6 is a block diagram showing an exemplary architecture for a central management system of the invention.

### DETAILED DESCRIPTION OF THE INVENTION

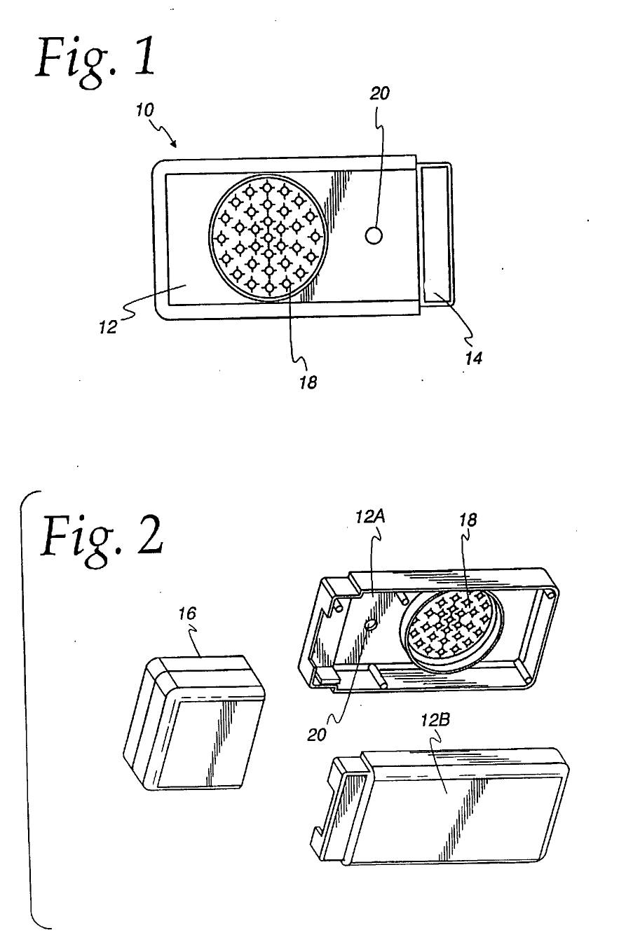

Referring to FIGS. 1 and 2, a memory stick 10 includes a housing 12 and a USB connector 14. In the exemplary embodiment shown, housing 12 is formed in two parts, a top portion 12A and a bottom portion 12B, which are assembled together to form completed housing 12. USB connector 14 is preferably a standard male type-A USB 2.0 connector which is compatible with USB 2.0 ports on most PC's. Preferably a cover 16 is provided for USB connector 14 to protect USB connector 14 when not connected to a USB port. Alternately, USB connector 14 may be retractable into housing 12 when not in use.

Top portion 12A is provided on one side with a speaker grill 18, which permits sound from a speaker mounted inside housing 12 to be audible to a user. An LED aperture 20 is also provided in housing 12.

Housing 12 and cover 16 are preferably made of rigid plastic, but may also be made of metal or another suitable material. The dimensions of housing 12 are preferably about 60 mm long by 25 mm wide by 10 mm high, but the exact dimensions and shape are not critical and may be varied as desired for aesthetics and convenience. Housing 12 and/or cover 16 may be printed with decorative designs, a company logo, a promotional message or other indicia.

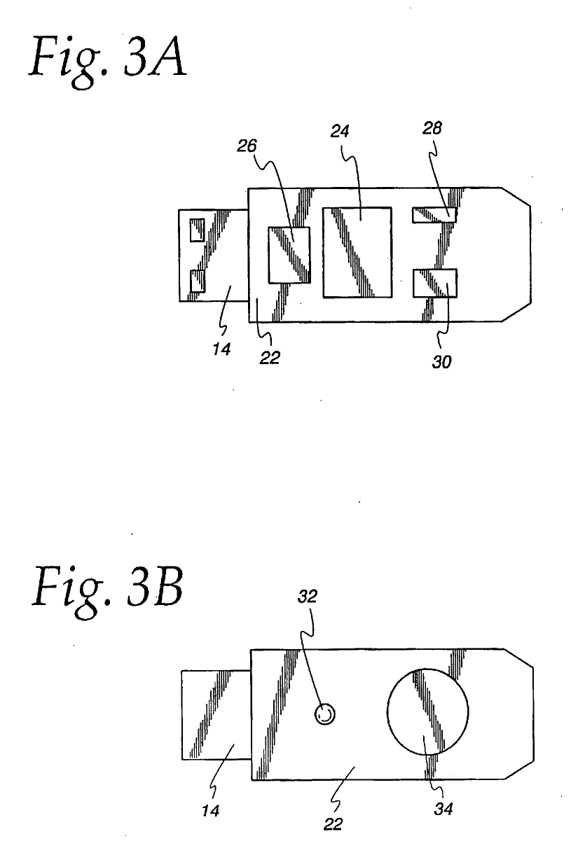

As shown in FIG. 3, the electronic components of the device are preferably mounted on a printed circuit board 22 which is sized and shaped to fit inside housing 12. Referring to FIG. 3A, the principal electronic components are a flash memory device 24, a USB controller 26, a crystal oscillator 28, and a sound chip 30, which are mounted on one side of printed circuit board 22. An LED 32 and a speaker 34 are mounted on the other side of printed circuit board 22 and are positioned in housing 12 in proximity to and alignment with LED aperture 20 and speaker grill 18, respectively. Of course, the exact layout of the components on printed circuit board 22 may be varied depending on the exact components selected and other factors.

NAND flash memories suitable for use in a USB memory stick are currently available in a range of memory capacities from about 64 MB to about 64 GB. An example of a suitable flash memory device is the HY27UF081G2M 1 GB flash memory from Hynix Semiconductor, Inc., but any flash memory device of the desired memory capacity may be selected.

Flash memory controllers typically include a small microprocessor and a small amount of on-chip ROM and RAM. The ROM contains the instructions for operating the controller. A suitable controller is the UB6210 Pen Drive Controller available from ENE Technology Inc. The UB6210 is a USB 2.0 mass storage class device controller designed for mapping NAND-type flash memories to disk for easy access. It is capable of operating at high speed (480 Mb/s). The UB6210 is available in a 48-pin surface mount package.

Flash memory device 24, USB controller 26 and oscillator 28 are connected as known in the art and operate as known in the art to provide a full-function memory stick, which may be used, for example, to transport data files conveniently between computers. That is, USB controller 26 controls all data read and write operations from and to flash memory 24, permitting data to be transferred quickly and easily between memory stick 10 and the user's computer. LED 32 is illuminated by controller 26 to indicate data transfers or data reads and writes.

Flash memory 24 is preferably partitioned into secure and non-secure portions, the secure portion being hidden from the user. The non-secure portion may be used in a conventional manner by the user to store any files and data, while the secure portion stores audio content, which may be dynamically updated, and interface software for connecting to a server and updating the audio content as described below. Alternately, a second flash memory may be provided, with one flash memory being secure and the other non-secure. Separating the portion of the flash memory that connects to a server via the Internet from the portion in which the user stores data helps to prevent the transmission of computer viruses.

Crystal oscillator 28 produces a clock signal for the memory stick circuit. Typically, the clock is 12 MHz and controls the memory stick's data output through a phase locked loop (PLL).

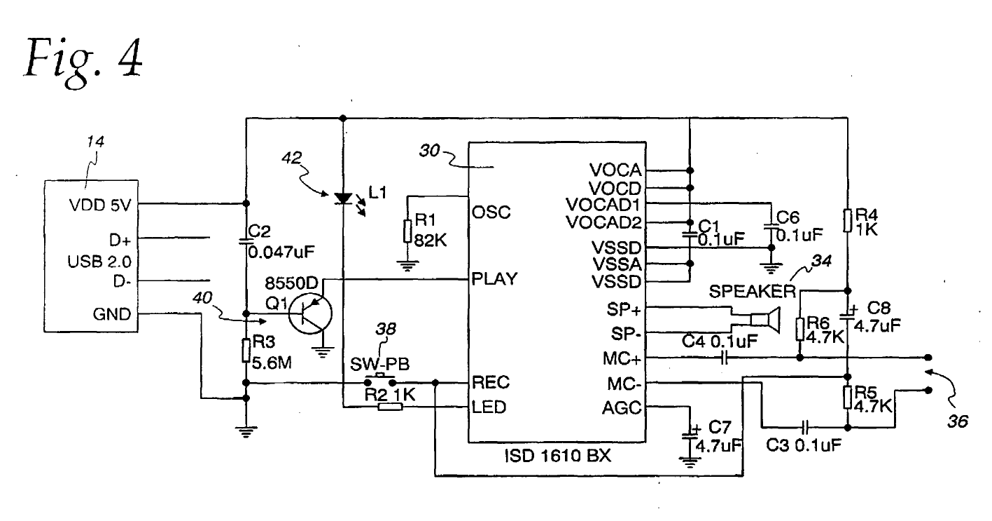

The audio feature of memory stick 10 is provided by a sound unit having a circuit such as that shown in the schematic of FIG. 4. Sound chip 30 is an integrated circuit with onboard memory and record and playback capabilities, such as the ISD 1610 BX. Speaker 34 is connected to the audio outputs (SP+ and SP−) of sound chip 30. Sound chip 30 is connected to power and ground and to various discrete resistors and capacitors as shown in FIG. 4 and as known in the art for proper operation of the circuit.

The desired audio, such as for example a promotional message or a message related to a sweepstakes or contest, is recorded and stored in sound chip 30. Typically, the initial pre-recorded message is simply recorded into onboard memory in sound chip 30 from an external audio source, such as a CD player, computer, etc., which is connected to the recording inputs (MIC+ and MIC−) of sound chip 30 at audio input terminals 36. The recording function is activated by closing a record switch 38 which is connected to the REC pin of sound chip 30. Alternately, sound chip 30 may be prerecorded before being installed in memory stick 10. This would facilitate mass recording of sound chips for production of numerous memory sticks with the same message. The audio content may be dynamically and remotely updated, e.g., a new message may be written to the sound chip, as described below. Alternately, several different messages may be pre-recorded in sound chip 30 or stored in flash memory 24, and the selection of which message to play may be dynamically and remotely modified.

The audio content may include music, a spoken message, sound effects, or a combination thereof as desired. Optionally, a small microphone (not shown) may be included in memory stick 10 and connected to the MIC+ and MIC− inputs of sound chip 30 via audio input terminals 36 to permit a user to record custom messages by pressing record switch 38 (e.g., through a small aperture in housing 12) and speaking into the microphone (also through a small aperture in housing 12). Alternately, speaker 34 may also function as a microphone as is known in the art to provide a recording input. LED 40 is connected to the LED pin of sound chip 30 and may be illuminated to indicate that sound chip 30 is in the record mode.

Sound chip 30 may include an analog-to-digital (A/D) converter for converting analog signals from audio input terminals 36 to digital form, memory for storing the digitized audio, a digital-to-analog (D/A) converter for converting the stored digitized audio back to an analog signal, an amplifier for amplifying the analog signal from the D/A converter, and an audio output for outputting the amplified analog signal to speaker 34.

Memory stick 10 does not have a battery or other on-board power source, and requires no other external power source. Instead, it obtains its operating voltages from the computer via the USB port of the computer (or a USB hub connected to one or more computers). Flash memory is non-volatile, i.e., does not require power to retain the contents of the memory. Standard components necessary for providing and distributing the operating voltages required by flash memory device 24, controller 26, sound chip 30 and the other components are provided on printed circuit board 22 as is known in the art.

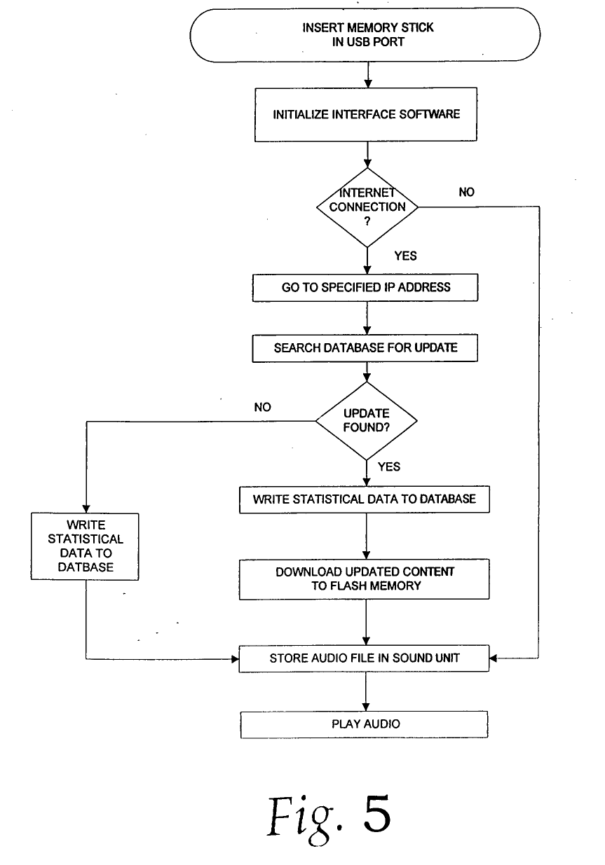

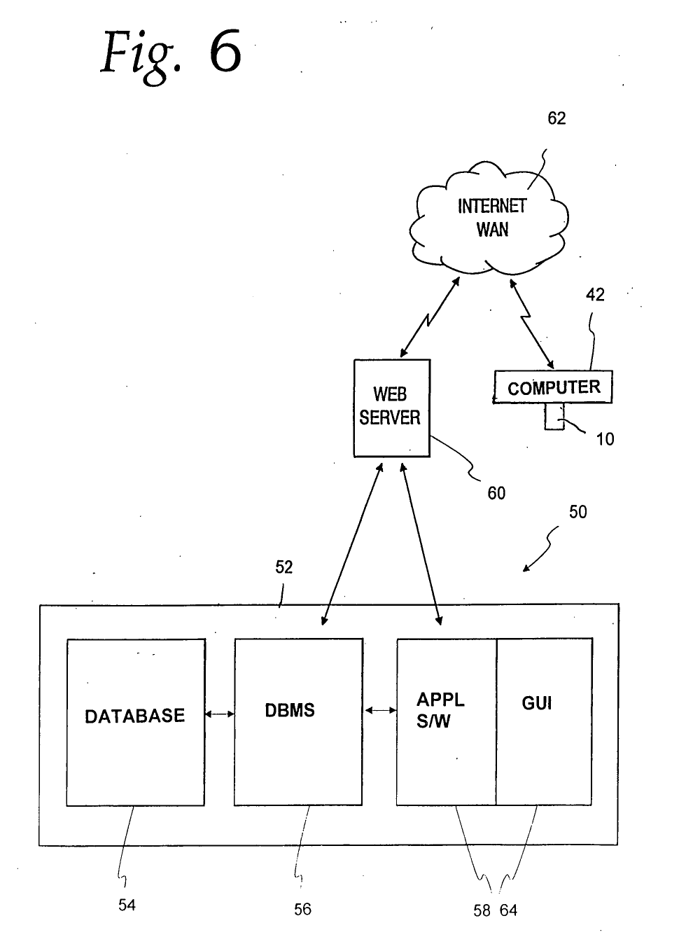

The operation of the memory stick is briefly described with reference to FIGS. 5 and 6. The user inserts USB connector 14 of memory stick 10 into a USB port on a host computer 42 (or a USB hub connected to one or more computers). Power from the USB port is immediately supplied via USB connector 14 to the circuitry of memory stick 10, which causes interface software in the secure portion of flash memory 24 to be initialized. The interface software then performs an Internet connection check. If there is an Internet connection, the interface software connects to a specified IP address pre-stored in the secure partition of flash memory 24. The IP address identifies a server 52 at a central management system 50 to which host computer 42 connects via Web server 60 and wide area network 62 (e.g., the Internet). Database management system (DBMS) software 56 searches for updated content in a database 54. The updated content may be, e.g., a new promotional message, a “coupon” for a special price on a product or service, a “thank you” message to a customer, or a musical ring tone.

If updated content is found, database management system software 56 writes statistical information to database 56 (e.g., identification of the user's operating system, date, time, identification of current update, etc.) and downloads the updated content to the secure partition in flash memory 24 of memory stick 10 via Web server 60, WAN 62 and host computer 42. The updated content may be a new audio file, or it may be an instruction to select a particular pre-recorded audio file already stored in flash memory 24 or sound chip 30. The interface software in memory stick 10 then writes any audio file in the updated content to sound chip 30, or, alternately, instructs sound chip 30 to play a specific pre-recorded file as indicated by the updated content. If the sound chip is of a type that supports it, the updated audio content may be downloaded directly to the memory in the sound chip without first being stored in the flash memory. Typically, the new audio content will be written over the old audio content, thus erasing the old content. Of course, if the sound chip has sufficient memory and it is desired to do so, the new audio content may be stored without erasing the old content. Once the downloading process is complete, or if no Internet connection is present, sound unit 30 is enabled causing playback of audio to begin.

The software sends a signal to the PLAY input on sound chip 30. This initiates playback of the recorded audio through speaker 34. Audio playback begins without the need for the computer's operating system to recognize the memory stick as a drive and without the user taking any action. Because memory stick 10 includes on-board speaker 34, it is not necessary for the user's computer to have its own speaker or any audio capabilities. If desired, a switch may be provided to permit the user to disable playback of the message.

The computer's operating system will also recognize the memory stick as a disk drive and prompt the user for instructions as to what the user wishes to do, e.g., open a folder to view the files in the flash memory, copy files to or from flash memory device 24, etc. Thus, after playing the prerecorded audio message, memory stick 10 functions as a standard USB memory device.

An example of a possible architecture of central management system 50 is shown in FIG. 6. Central management system 50 permits a system administrator, such as a party who distributes memory sticks with promotional messages or a third-party system operator, to provide updated audio content and collect data from the memory sticks when each one is connected to central management system 50 for updating. Central management system 50 operates on server 52 or another computer connected to wide area network (WAN) 62, such as the Internet, and has a unique IP address which is stored in the secure portion of flash memory 24 in memory stick 10. Server 52 includes database 54 with a suitable database management system (DBMS) 56, a software application for uploading of audio files 58, Web server 60 for communication via WAN 62, and a graphical user interface 64 providing secure login by the system administrator, database management, access for uploading audio files, display of stored user statistics, and other features.

Using uploading application 58, the system administrator uploads audio files from any source, previews them, crops them to a desired length (e.g., 10 seconds), and saves them in database 54. When a user's memory stick 10 is connected to server 52 via WAN 62, server 52 recognizes memory stick 10 (by, e.g., an ID code stored in flash memory 24) and searches database 54 using DBMS 56 for updated audio content associated with that memory stick. The updated audio content is then downloaded to memory stick 10. Statistical data may be collected and stored in database 54, e.g., the date and time of the update. This permits the system administrator to track, for example, how many times and how often a user plugs in the memory stick, and thus obtain metrics on the effectiveness of a promotional campaign.

While the invention has been described with respect to certain preferred embodiments, as will be appreciated by those skilled in the art, it is to be understood that the invention is capable of numerous changes, modifications and rearrangements and such changes, modifications and rearrangements are intended to be covered by the following claims.

What is claimed is:

1. A portable data storage device, comprising:
a connective port electrically connectable to a host machine, whereby the host machine provides power to the portable data storage device;
a non-volatile memory unit;
a memory controller for controlling the transfer of data between the non-volatile memory and the host machine via the connective port;
a sound transducer;
a sound unit for storing recorded audio content and playing the stored audio content through the sound transducer when the connective port is connected to the host machine; and
interface software stored in the non-volatile memory unit for automatically connecting the host machine to a remote server, receiving updated audio content from the remote server, and providing the updated audio content to the sound unit.

2. The portable data storage device of claim 1 wherein the connective port is a USB port.

3. The portable data storage device of claim 1 wherein the non-volatile memory comprises flash memory.

4. The portable data storage device of claim 1 wherein the audio content comprises a promotional message.

5. The portable data storage device of claim 1 wherein the audio content comprises a message related to a sweepstakes or contest.

6. The portable data storage device of claim 1 wherein the updated content comprises an instruction to the sound unit to play a particular pre-recorded audio file.

7. The portable data storage device of claim 1 wherein the non-volatile memory is partitioned into a secure portion and a non-secure portion, the interface software being stored in the secure portion.

8. The portable data storage device of claim 1 wherein the sound unit comprises an analog audio input, an A/D converter for converting analog signals from the analog audio input to digital form, memory for storing the digitized audio, a D/A converter for converting the stored digitized audio to an analog signal, an amplifier for amplifying the analog signal from the D/A converter, and an audio output for outputting the amplified analog signal to the sound transducer.

9. The portable data storage device of claim 1 further comprising user-activated means for disabling playing the audio content.

10. A system for dynamically updating audio content stored in portable data storage devices, comprising:
a central management system comprising a database,
a plurality of portable data storage devices, each portable data storage device comprising a connective port being electrically connectable to a host machine, a non-volatile memory unit, a memory controller for controlling the transfer of data between the non-volatile memory and the host machine via the connective port, a loudspeaker, a sound unit for storing recorded audio content and playing the stored audio content through the speaker when the port is connected to the host machine, and interface software stored in the non-volatile memory unit for automatically connecting the host machine to the central management system, receiving updated audio content from the central management system, and storing the updated audio content in the sound unit.

11. The system of claim 10 wherein the host machine connects to the central management system via the Internet.

12. The system of claim 11 wherein the central management system comprises a server, an IP address uniquely identifying the server is stored in the non-volatile memory of the portable data storage devices, and the interface software uses the IP address to connect to the server.

13. The system of claim 10 wherein the audio content comprises a promotional message.

14. The system of claim 10 wherein the central management system comprises database management software which searches the database for updated audio content associated with the portable data storage device.

15. The system of claim 10 wherein the database stores statistical data associated with the portable storage device.

16. A method for dynamically updating and automatically playing audio content from a portable data storage device, comprising:
providing a portable data storage device having a connective port electrically connectable to a host machine whereby the host machine provides power to the portable data storage device, a non-volatile memory unit, a memory controller for controlling the transfer of data between the non-volatile memory and the host machine via the connective port, a sound transducer, and a sound unit;
storing audio content in the sound unit;
automatically connecting the host machine to a remote server, receiving updated audio content from the remote server, and storing the updated audio content in the sound unit, and
automatically playing the audio content from the sound unit through the sound transducer.

17. The method of claim 16 wherein the connective port is a USB connector.

18. The method of claim 16 wherein the non-volatile memory unit comprises flash memory.

19. The method of claim 16 wherein the audio content comprises a promotional message.

20. The method of claim 16 wherein the audio content comprises a message related to a sweepstakes or contest.
